(19) United States
(12) Patent Application Publication
(10) Pub. No.: US 2026/0222031 A1
(43) Pub. Date: Jul. 30, 2026

(54) METHODS AND APPARATUSES SUPPORTING USER EQUIPMENT CHANNEL STATE INFORMATION PREDICTION

(71) Applicant: APPLE INC., Cupertino, CA (US)

(72) Inventors: Haitong Sun, Cupertino, CA (US); Dawei Zhang, Saratoga, CA (US); Weidong Yang, San Diego, CA (US); Wei Zeng, San Diego, CA (US); Oghenekome Oteri, San Diego, CA (US); Dan Wu, Beijing (CN)

(21) Appl. No.: 19/145,323

(22) PCT Filed: Feb. 15, 2023
(86) PCT No.: PCT/CN2023/076168

§ 371 Date: Jul. 2, 2025

(51) Int. Cl. H04B 7/06; H04L 5/00; H04W 72/0446

(52) U.S. Cl. CPC H04B 7/0626; H04L 5/0044; H04W 72/0446

(57) ABSTRACT

Methods and apparatuses supporting user equipment (UE) channel state information (CSI) prediction are disclosed herein. A UE may receive, from a network, configuration information for generating predictive CS) corresponding to a CSI valid time (T_{CSI}) occurring after a CSI reference signal (RS) time (T_{RS}) for an RS received at the UE for generating the predictive CSI in the case where the T_{CSI} occurs after a duration d following a CSI prediction reference time (T_{ref,CSI}). The UE may proceed to generate, based on a measurement of the RS, the predictive CSI corresponding to the T_{CSI}. The UE may then transmit, to the network, the predictive CSI at a CSI report time (Tᵣₑₚₒᵣₜ). Mechanisms for selecting T_{ref,CSI} are discussed. Mechanisms used between the network and the UE for communicating one or more durations d to the UE corresponding to one or more CSI reports are discussed.

### TECHNICAL FIELD

This application relates generally to wireless communication systems, including support for UE CSI prediction.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a timeline showing aspects related to the transmission of a CSI report based on a received RS, according to embodiments herein.

FIG. 2 illustrates a timeline showing aspects related to the transmission of a CSI report based on a received RS, according to embodiments herein.

FIG. 3 illustrates an example an CSI-ReportConfig IE used as part of RRC signaling that may contain a CSI-prediction value representing a duration d, according to embodiments herein.

FIG. 4 illustrates a MAC-CE that communicates one or more durations d from T_{ref,CSI} corresponding to one or more T_{CSI} for one or more predictive CSIs, according to embodiments herein.

FIG. 5 illustrates an example of a CSI-ReportConfig IE used as part of RRC signaling that may contain a semiPersistentOnPUCCH sequence having a CSI-prediction value representing a duration d, according to embodiments herein.

FIG. 6 illustrates a MAC-CE that communicates one or more durations d from T_{ref,CSI} corresponding to one or more T_{CSI} for one or more predictive CSIs, according to embodiments herein.

FIG. 7A illustrates a first possible case for configuring a duration d from a T_{ref,CSI} for predictive CSI using an SP CSI report on a PUSCH, according to embodiments herein.

FIG. 7B illustrates a second possible case for configuring a duration d from a T_{ref,CSI} for predictive CSI using an SP CSI report on a PUSCH, according to embodiments herein.

FIG. 8A illustrates a first possible case for configuring a duration d from a T_{ref,CSI} for predictive CSI using an aperiodic CSI report on a PUSCH, according to embodiments herein.

FIG. 8B illustrates a second possible case for configuring a duration d from a T_{ref,CSI} for predictive CSI using an aperiodic CSI report on a PUSCH, according to embodiments herein.

FIG. 8C illustrates a third possible case for configuring a duration d from a T_{ref,CSI} for predictive CSI using an aperiodic CSI report on a PUSCH, according to embodiments herein.

FIG. 9 illustrates a method of a UE, according to embodiments herein.

FIG. 10 illustrates a method of a RAN, according to embodiments herein.

FIG. 11 illustrates an example architecture of a wireless communication system, according to embodiments disclosed herein.

FIG. 12 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

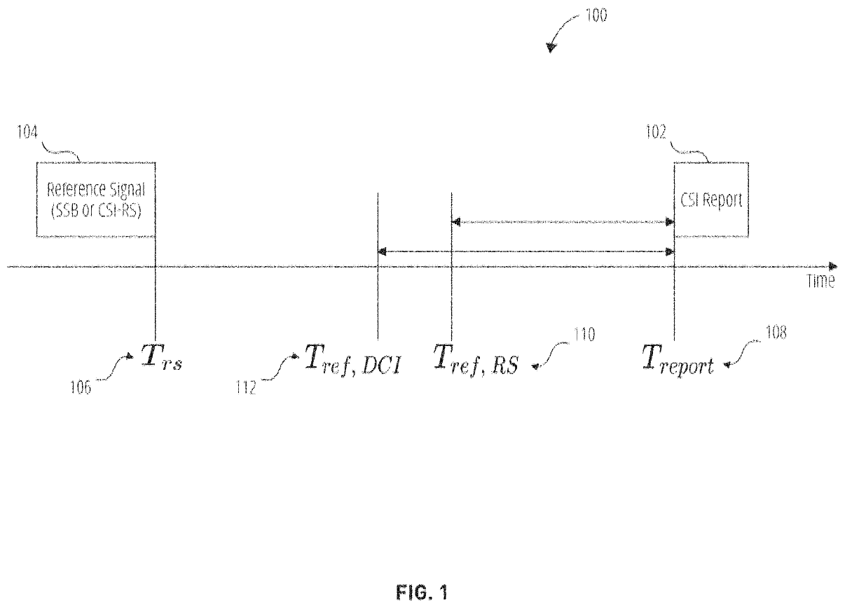

FIG. 1 illustrates a timeline 100 showing aspects related to the transmission of a channel state information (CSI) report 102 based on a received reference signal (RS) 104, according to embodiments herein. The CSI report 102 is an example of “CSI feedback” as referred to herein.

FIG. 1 illustrates various particular times that may be defined with respect to the use of CSI feedback (e.g., as may be defined in a specification of the wireless communication system). A CSI RS time 106 may be denoted T_{RS}. The T_{RS} 106 may correspond to an end of a last RS used for a CSI measurement. As illustrated, the RS in question may be, in some wireless communication systems, a channel state information reference signal (CSI-RS) or a synchronization signal block (SSB) that is received at the UE as transmitted by the network.

A CSI report time 108 may be denoted Tᵣₑₚₒᵣₜ. The Tᵣₑₚₒᵣₜ 108 may correspond to a beginning or end of the physical channel (e.g., a physical uplink control channel (PUCCH) or a physical uplink shared channel (PUSCH) that carries the CSI report 102.

A CSI reference resource for RS 110 may be denoted T_{ref,RS}. The T_{ref,RS} 110 may correspond to a latest time by which the RS 104 can arrive and still be used for CSI measurement corresponding to the CSI report 102 (e.g., in order to meet the illustrated time for the CSI report 102). In some cases, the T_{ref,RS} 110 is counted as a number of symbols backward in time from the Tᵣₑₚₒᵣₜ 108. In some such cases, when periodic or semi-persistent CSI is used, the T_{ref,RS} 110 is 4 ms (for the case of a single RS) or 5 ms (for the case of multiple RS) ahead of the Tᵣₑₚₒᵣₜ 108. In some such cases, when aperiodic CSI is used, the T_{ref,RS} 110 is Z′ symbols ahead of the Tᵣₑₚₒᵣₜ 108, (e.g., where Z′ may be a valued defined in a specification for the wireless communication system; see, e.g., 3GPP Technical Specification (TS) 38.214, version 17.4.0, section 5.2.2.5 and section 5.4 (December 2022)).

A CSI reference time defined based on downlink control information (DCI) may be denoted T_{ref,DCI}. The T_{ref,DCI} 112 may correspond to a latest time that a DCI that triggers the measurement of the RS 104 and/or the transmission of the corresponding CSI report 102 can arrive at UE (e.g., in order to meet the illustrated time for the CSI report 102). The T_{ref,DCI} 112 may be applicable with respect to/in the case of aperiodic CSI, and may be counted as a number of symbols backward in time from the Tᵣₑₚₒᵣₜ 108. In the case of aperiodic CSI, the Tᵣₑₚₒᵣₜ 108 may be located Z symbols ahead of the Tᵣₑₚₒᵣₜ 108 (where Z may be a value defined in a specification for the wireless communication system; see, e.g., 3GPP TS 38.214, version 17.4.0, section 5.4 (December 2022)).

It may be that some wireless communications systems do not support CSI prediction behavior. For example, a UE may measure CSI based on the reference signal transmitted at the T_{RS} 106 and report CSI in a further time (e.g., the Tᵣₑₚₒᵣₜ 108). In such cases, the CSI report 102 represents the channel as it was observed in the past (at the T_{RS} 106).

Herein, the accuracy drift (from the network perspective) for CSI in the CSI report 102 due to the time gap running from the receipt of the RS at the UE at T_{RS} 106 until the transmission of the CSI report 102 at the Tᵣₑₚₒᵣₜ 108 may be referred to as “CSI aging.” Such CSI aging may be caused due to a need to provide, at minimum, some CSI processing time within this period prior to the sending of the CSI report 102. However, due to this CSI aging, the CSI report 102 can be outdated, (due to the delay between the CSI report 102 and the T_{RS} 106).

It may accordingly be beneficial to establish a framework for the use of UE-side CSI prediction, wherein the UE generates and then sends, to the network, predictive CSI for the channel. This predictive CSI may correspond to (e.g., inform regarding a predicted state of the channel at) some time after the T_{RS} 106. Accordingly, it may be understood that such predictive CSI provides the network information that, while predictive, is not as aged as CSI based on strictly the measurement of the RS 104.

It is contemplated that predictive CSI may be generated based on, for example, a measurement of the RS 104, optionally in conjunction with a CSI measurement history kept at the UE. Further, a UE velocity and/or direction may be taken into account when generating predictive CSI. Other methods/combinations of factors are contemplated.

CSI prediction may be particularly useful in cases of high or medium velocity UEs, where the issues with CSI aging may be more pronounced due to the relatively rapid physical displacement of the UE relative to its serving cell (however, note that cases of low or no velocity of the UE could also beneficially use mechanisms for predictive CSI as contemplated herein).

Proposals herein relate to the design and/or support of CSI prediction reference time definitions and CSI prediction time configurations.

### CSI Prediction Reference Time Definition

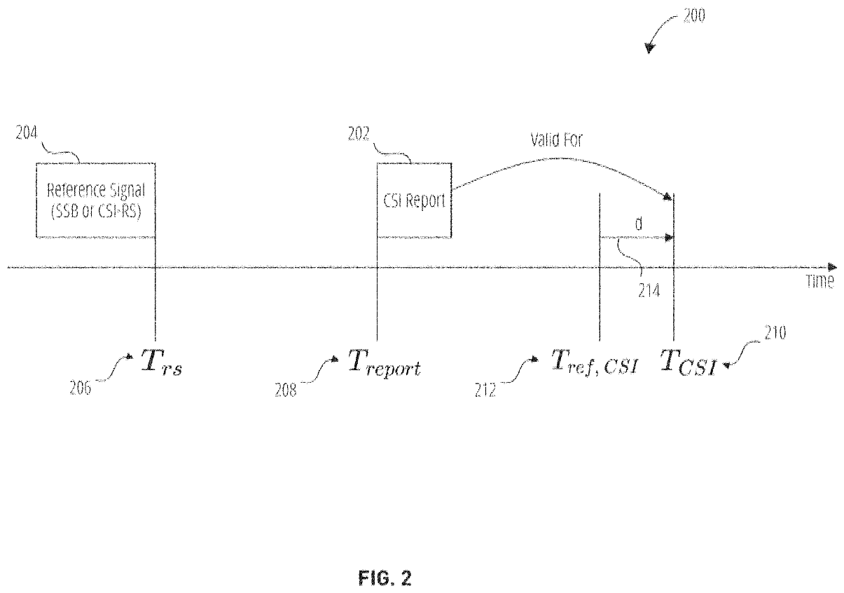

FIG. 2 illustrates a timeline 200 showing aspects related to the transmission of a CSI report 202 based on a received RS 204, according to embodiments herein. The CSI report 202 is an example of “CSI feedback” as referred to herein.

With respect to a framework supporting CSI prediction, various particular times may be defined. Preliminarily, note that a T_{RS} 206 and a Tᵣₑₚₒᵣₜ 208 may be understood as these terms have been previously described herein (e.g., in relation to FIG. 1).

Further, a CSI valid time 210 may be denoted T_{CSI}. The T_{CSI} 210 may represent the time for which CSI provided in the CSI report 202 applies. This means that, for example, in the case where no predictive CSI is used, the T_{CSI} 210 is equal to the T_{RS} 206. However, in predictive CSI embodiments, because predictive CSI corresponds to (e.g., represents predicted CSI for) some time after T_{RS} 206, it may be understood that the T_{CSI} 210 is later than the T_{RS} 206 (as illustrated in FIG. 2).

In some embodiments, to support CSI prediction, the network may configure/indicate the T_{CSI} 210 for a CSI measurement/report performed by the UE. In some embodiments, the T_{CSI} 210 may be configured/indicated in terms of a variable duration d 214 that is measured from a CSI prediction reference time 212 (which may be denoted T_{ref,CSI}), as illustrated in FIG. 2. The duration d 214 can be configured/indicated in terms of symbols. Note that while in FIG. 2, the duration d 214 is illustrated as a positive value, the use of a duration d that is a negative value is also contemplated for other embodiments.

With respect to this network configuration/indication of the T_{CSI} 210 (e.g., in terms of a duration d 214 from a T_{ref,CSI} 212), the following designs for the T_{ref,CSI} 212 are contemplated.

In first cases, it may be that the T_{ref,CSI} 212 is fixed (e.g., in a specification for the wireless communication system). For example, the T_{ref,CSI} 212 may be set to the Tᵣₑₚₒᵣₜ 208 (T_{ref,CSI}=Tᵣₑₚₒᵣₜ), which is the beginning or end of the physical channel (e.g., the PUCCH or the PUSCH) that carries the CSI report 202. In another example, the T_{ref,CSI} 212 may be set to a T_{ref,RS} (see, e.g., the T_{ref,RS} 110 of FIG. 1) (T_{ref,CSI}=T_{ref,RS}), which is a latest time of arrival for the RS 204. In another example, the T_{ref,CSI} 212 may be set to the T_{RS} 206 (T_{ref,CSI}=T_{RS}), which corresponds to the end of the RS 204. In another example, the T_{ref,CSI} 212 may be set to a T_{ref,DCI} (see, e.g., the T_{ref,DCI} 112 of FIG. 1) (T_{ref,CSI}=T_{ref,DCI}), which is a latest time for a DCI triggering the CSI report 202.

Further, as to these options under the first cases, it may be that the network can indicate to the UE which such option to use. This indication may arrive at the UE via any of radio resource control (RRC) signaling, a medium access control control element (MAC-CE) and/or DCI. It is contemplated that in some cases, the network may toggle the UE between multiple of these options via subsequent such indications.

In second cases, it may be that the T_{ref,CSI} 212 is a value configured by the network (e.g., a directly indicated value of/for the T_{ref,CSI} 212). This information may be provided to the UE via any of RRC signaling, a MAC-CE and/or DCI.

Note that while FIG. 2 illustrates that the T_{CSI} 210 and the T_{ref,CSI} 212 are located in time after the CSI report 202, this is not required. A valid predictive CSI under the framework illustrated is CSI for a T_{CSI} 210 that occurs anywhere after the T_{RS} 206, (e.g., as described above). Accordingly, any placement of T_{ref,CSI} 212 that results with the T_{CSI} 210 occurring anywhere after the T_{RS} 206 results in a valid predictive CSI arrangement.

### CSI Prediction Time Configuration

With respect to the configuration of a T_{CSI}, there may be various applicable cases that should be considered. A first such case uses periodic CSI on a PUCCH. In this case, the periodic CSI is configured and/or released by RRC signaling. A second such case uses semi-persistent (SP) CSI on a PUCCH. In this case, the SP CSI is activated and/or deactivated by MAC-CE. A third such case uses SP CSI on a PUSCH. In this case, the SP CSI is activated and/or deactivated by DCI. A fourth such case uses aperiodic CSI on a PUSCH. In this case, the aperiodic CSI is triggered by DCI.

Configurations/indications for value(s) of a duration d to be used with respect to a T_{ref,CSI} to define a T_{CSI} (e.g., as is described herein (see FIG. 2 and related description)) are now discussed.

First proposals for communicating the duration d to the UE relate to the case of a periodic CSI report on a PUCCH.

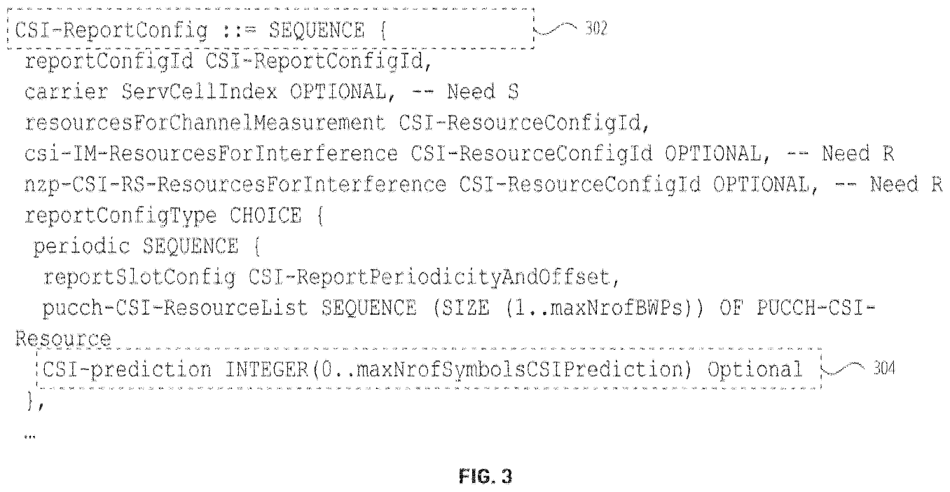

In a first option under the first proposals, it may be that the duration d is configured by RRC signaling. FIG. 3 illustrates an example an CSI-ReportConfig IE 302 used as part of this RRC signaling that may contain a CSI-prediction value 304 (representing the duration d), according to embodiments herein. Note that in the case that the CSI-prediction value 304 of the CSI-ReportConfig IE 302 is not configured, the UE may determine not to perform CSI prediction methods.

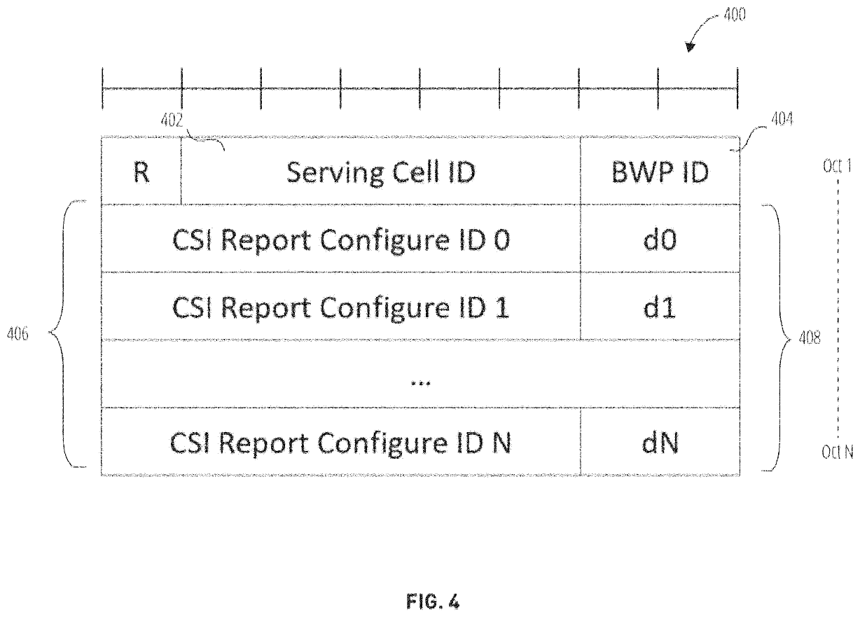

In a second option under the first proposals, a MAC-CE may be used to communicate one or more duration(s) d to the UE. FIG. 4 illustrates a MAC-CE 400 that communicates one or more durations d from T_{ref,CSI} corresponding to one or more T_{CSI} for one or more predictive CSIs, according to embodiments herein. The MAC-CE 400 may include a serving cell ID 402 and a bandwidth part (BWP) ID 404 identifying the applicable serving cell and bandwidth part, respectively.

Further, the MAC-CE 400 may include one or more CSI report configure ID fields 406 identifying the CSI-ReportConfigIDs for corresponding CSI-ReportConfig objects for activated CSI reports at the UE.

Finally, MAC-CE 400 may include one or more duration fields 408. Each of the duration fields 408 indicates a duration d for the CSI-ReportConfig object identified by a corresponding one of the CSI report configure ID fields 406 (where corresponding ones of the CSI report configure ID fields 406 and the duration fields 408 may share a same octet in the MAC-CE 400, as illustrated).

In the example illustrated in FIG. 4, the duration fields 408 each take two bits. Accordingly, a maximum of four different durations d (0, 1, 2, and 3) may be configured by each of the duration fields 408 for its corresponding CSI-ReportConfig object.

In some embodiments, it may be that a MAC-CE analogous to the design just described includes only one of the CSI report configure ID fields 406 and a corresponding one of the duration fields 408. In such systems, it may be that additional such MAC-CEs may be used to cause changes for an additional/different pair of CSI report configured ID field/duration field.

In other embodiments, a MAC-CE can have two or more such pairs (and note that the use of four such pairs in the MAC-CE 400 is given by way of example and not by way of limitation).

Second proposals for communicating the duration d to the UE relate to the case of a SP CSI report on a PUCCH (e.g., as activated by a MAC-CE).

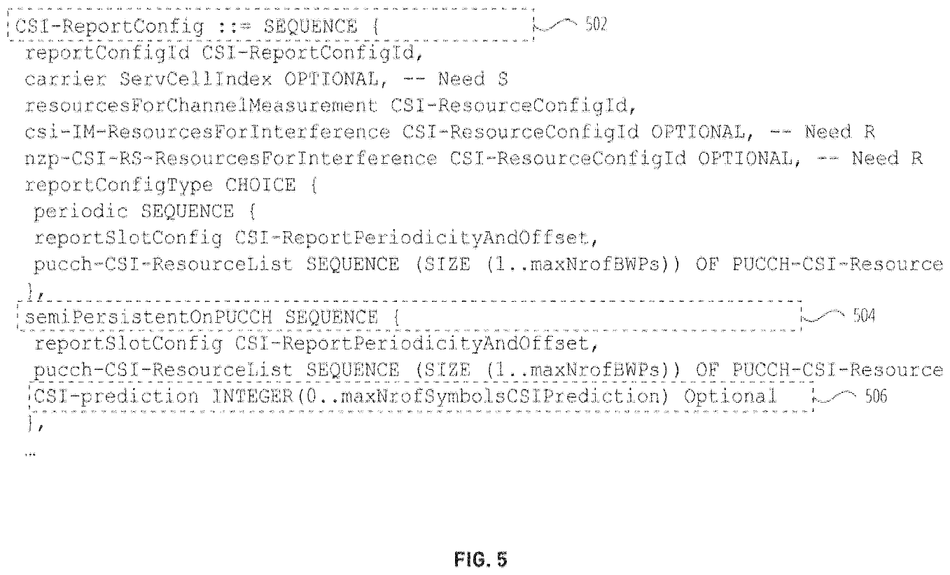

In a first option under the second proposals, it may be that the duration d is configured by RRC signaling. FIG. 5 illustrates an example a CSI-ReportConfig IE 502 used as part of this RRC signaling that may contain semiPersistentOnPUCCH sequence 504 having a CSI-prediction value 506 (representing the duration d), according to embodiments herein. Note that in some such embodiments, in the case that the CSI-prediction value 506 of the semiPersistentOnPUCCH sequence 504 of the CSI-ReportConfig IE 502 is not configured, the UE may determine not to perform CSI prediction methods.

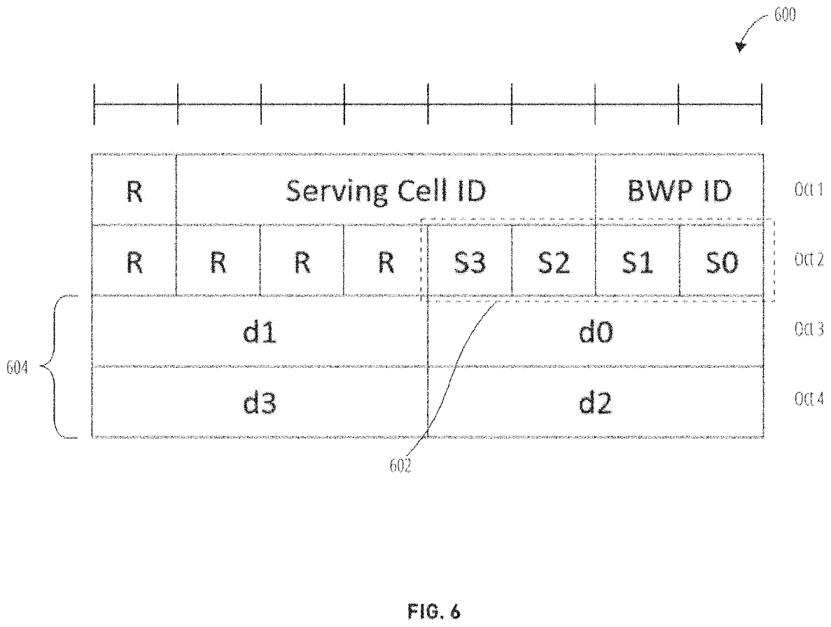

In a second option under the second proposals, the MAC-CE that activates the SP CSI report on the PUCCH may be used to communicate the duration d at the UE. FIG. 6 illustrates a MAC-CE 600 that communicates one or more durations d from T_{ref,CSI} corresponding to one or more T_{CSI} for one or more predictive CSIs, according to embodiments herein. The MAC-CE 600 may be used according to second proposals involving SP CSI reporting on a PUCCH.

It may be that up to four SP CSI can be configured. Accordingly, the MAC-CE uses a four bit bitmap 602 (including bits S3, S2, S1, S0) to activate/deactivate corresponding SP CSI(s). Further, new fields can be introduced in the MAC-CE 600 for each activated SP CSI to configure the applicable duration d for that SP CSI.

For example, the duration fields 604 (including fields d0, d1, d2, d3) give independent values for the duration d (e.g., in terms of symbols) for each of first, second, third, and/or fourth CSI-ReportConfig IEs of SP CSIs on PUCCH that have been configured (e.g., corresponding to activated ones of the SP CSIs indicated in the bitmap 602).

In this example, there may be up to 16 different durations d (0, 1, 2, . . . , 15) that can be configured for each CSI-ReportConfig, due to the fact that each field uses four bits.

In some embodiments, the MAC-CE 600 may include all four duration fields 604, regardless of the number of SP CSIs activated by the MAC-CE 600 (e.g., corresponding to the bitmap 602). In other embodiments, only SP CSI(s) on PUCCH having CSI-ReportConfig that are activated (e.g., via the bitmap 602) have a corresponding duration field 604 in the MAC-CE 600 (this may save signaling resource with respect to the transmission of the MAC-CE 600).

Third proposals for communicating the duration d to the UE relate to the case of a SP CSI report on a PUSCH (e.g., as activated by DCI).

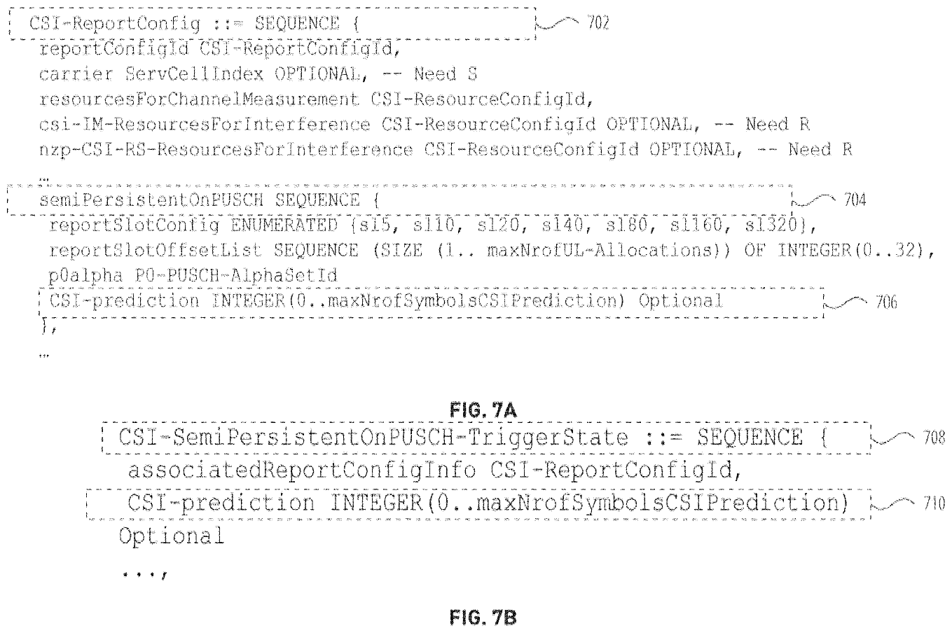

In a first option under the third proposals, it may be that the duration d is configured by RRC signaling. FIG. 7A illustrates a first possible case under the first option (using RRC signaling). In the first possible case, a CSI-ReportConfig IE 702 used as part of the RRC signaling may contain a semiPersistentOnPUSCH sequence 704 having a CSI-prediction value 706 (representing the duration d). Note that in some such embodiments, if the CSI-prediction value 706 of the semiPersistentOnPUSCH sequence 704 of the CSI-ReportConfig 1E 702 is not configured, the UE may determine not to perform CSI prediction methods.

FIG. 7B illustrates a second possible case under the first option (using RRC signaling). In the second possible case, a CSI-SemiPersistentOnPUSCH-TriggerState IE 708 is used as part of the RRC signaling and includes a CSI-prediction value 710 (representing the duration d). The use of the CSI-SemiPersistentOnPUSCH-TriggerState IE 708 (as opposed to, e.g., the use of the semiPersistentOnPUSCH sequence 704 of the CSI-ReportConfig 1E 702 of FIG. 7A) to communicate the CSI-prediction value 710 may allow the network to set the duration d corresponding to the CSI-prediction value 710 with on a trigger-state granularity basis.

In a second option under the third proposals, a MAC-CE may be used to communicate the duration d at the UE. The MAC-CE used in the second option of the third proposal may be, for example, analogous to the MAC-CE 400 described in relation to FIG. 4.

In a third option under the third proposals, the duration d can be dynamically indicated by the DCI that activates the SP CSI on the PUSCH. In some such cases, an existing field (e.g., a time domain resource allocation (TDRA) field) field could be used to indicate the duration d. In some such cases, a new field may be introduced.

Under this third option, various cases may be considered. In a first case, a dynamic indication in the DCI of the duration d may directly indicate an absolute number of symbols of the duration d.

In a second case, the dynamic indication in the DCI may be given in terms of a table index. The UE may be configured with a corresponding table for various values of the duration d, and may apply the table index within the table to determine a particular one of these durations d that applies. The table may be configured to the UE via either RRC signaling or by a MAC-CE, and may be provided to the UE on a per-SP-CSI-report-configuration basis.

Fourth proposals for communicating the duration d to the UE relate to the case of an aperiodic CSI report on a PUSCH (e.g., as triggered by DCI).

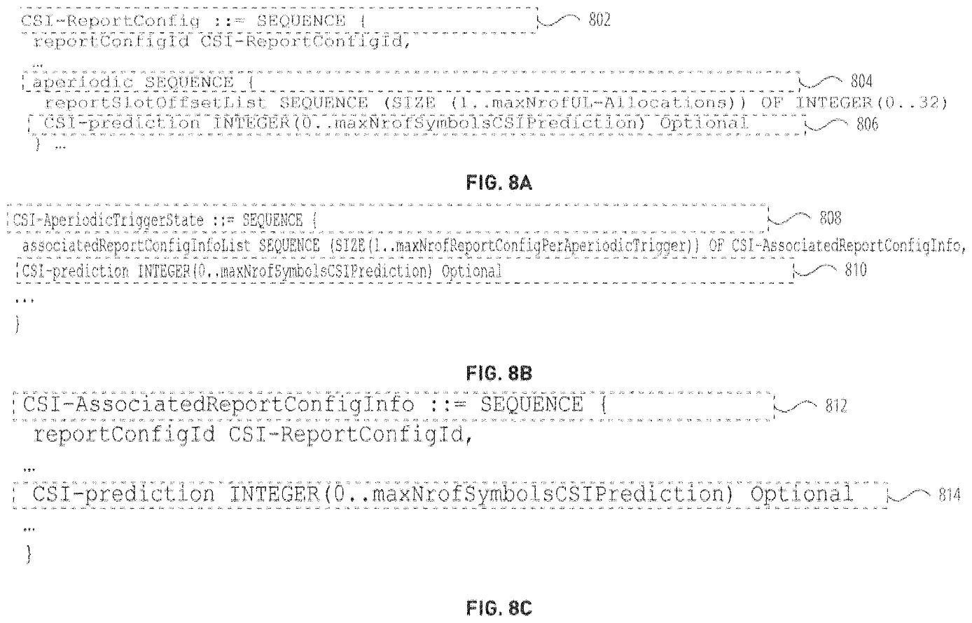

In a first option under the fourth proposals, it may be that the duration d is configured by RRC signaling. FIG. 8A illustrates a first possible case under the first option (using RRC signaling). In the first possible case, a CSI-ReportConfig IE 802 used as part of the RRC signaling may contain an aperiodic sequence 804 having a CSI-prediction value 806 (representing the duration d). Note that in some such embodiments, if the CSI-prediction value 806 of the aperiodic sequence 804 of the CSI-ReportConfig IE 802 is not configured, the UE may determine not to perform CSI prediction methods.

FIG. 8B illustrates a second possible case under the first option (using RRC signaling). In the second possible case, a CSI-AperiodicTriggerState IE 808 used as part of the RRC signaling includes a CSI-prediction value 810 (representing the duration d). The use of the CSI-AperiodicTriggerState IE 808 (as opposed to, e.g., the use of the aperiodic sequence 804 of the CSI-ReportConfig IE 802 of FIG. 8A) to communicate the CSI-prediction value 810 may allow the network to set the duration d corresponding to the CSI-prediction value 810 on a trigger-state granularity basis.

FIG. 8C illustrates a third possible case under the first option (using RRC signaling). In the third possible case, a CSI-AssociatedReportConfigInfo IE 812 used as part of the RRC signaling includes a CSI-prediction value 814 (representing the duration d). The use of the CSI-AssociatedReportConfigInfo IE 812 (as opposed to, e.g., the use of the aperiodic sequence 804 of the CSI-ReportConfig IE 802 as in FIG. 8A or the CSI-AperiodicTriggerState IE 808 as in FIG. 7B) to communicate the CSI-prediction value 814 may allow the network to set the duration d corresponding to the CSI-prediction value 814 on an associated-report-configuration granularity basis.

In a second option under the fourth proposals, a MAC-CE may be used to communicate the duration d at the UE. The MAC-CE used in the second option of the fourth proposal may be, for example, analogous to the MAC-CE 400 described in relation to FIG. 4.

In a third option under the fourth proposals, the duration d can be dynamically indicated by the DCI that activates the aperiodic CSI on the PUSCH. In some such cases, an existing field (e.g., a CSI request) could be used to indicate the duration d. In some such cases, a new field may be introduced.

Under this third option, various cases may be considered. In a first case, a dynamic indication in the DCI of the duration d may directly indicate an absolute number of symbols for the duration d. In a first sub-case, an indication of a duration d in the DCI may be shared for all aperiodic CSIs scheduled by that DCI. In a second sub-case, independent indication(s) of duration(s) d may be provided in the DCI corresponding to sub-groups and/or individual ones of all the aperiodic CSIs scheduled by that DCI.

In a second case, the dynamic indication in the DCI may be given in terms of a table index. The UE may be configured with a corresponding table for various values of the duration d, and may apply the table index within the table to determine a particular one of these durations d that applies. The table may be configured to the UE via either RRC signaling or by a MAC-CE, and may be provided to the UE on a per-SP CSI report configuration basis.

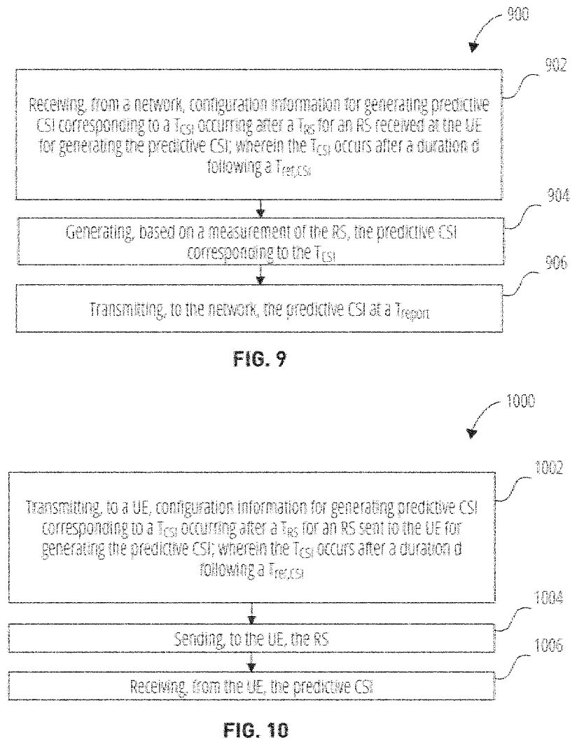

FIG. 9 illustrates a method 900 of a UE, according to embodiments herein. The method 900 includes receiving 902, from a network, configuration information for generating predictive CSI corresponding to a T_{CSI} occurring after a T_{RS} for an RS received at the UE for generating the predictive CSI; wherein the T_{CSI} occurs after a duration d following a T_{ref,CSI}.

The method 900 further includes generating 904, based on a measurement of the RS, the predictive CSI corresponding to the T_{CSI}.

The method 900 further includes transmitting 906, to the network, the predictive CSI at a Tᵣₑₚₒᵣₜ.

In some embodiments of the method 900, the configuration information indicates that the T_{ref,CSI} ais equal to the Tᵣₑₚₒᵣₜ.

In some embodiments of the method 900, the configuration information indicates that the T_{ref,CSI} ais equal to a T_{ref,RS}.

In some embodiments of the method 900, the configuration information indicates that the T_{ref,CSI} is equal to the IRS for the RS.

In some embodiments of the method 900, the configuration information indicates that the T_{ref,CSI} ais equal to a T_{ref,DCI}.

In some embodiments of the method 900, the configuration information comprises a value of the T_{ref,CSI}.

In some embodiments of the method 900, the predictive CSI comprises a periodic CSI that is sent on a PUCCH, and the method 900 further includes: receiving, from the network, an RRC message comprising a CSI-ReportConfig IE comprising a value for the duration d; and receiving, from the network, MAC-CE comprising the value for the duration d.

In some embodiments of the method 900, the predictive CSI comprises a semi-persistent CSI that is sent on a PUCCH and that is activated by a MAC-CE, and the method 900 further includes receiving, from the network, an RRC message comprising a CSI-ReportConfig 1E comprising a value for the duration d.

In some embodiments of the method 900, the predictive CSI comprises a semi-persistent CSI that is sent on a PUCCH and that is activated by a MAC-CE, and wherein the MAC-CE comprises a value for the duration d.

In some embodiments of the method 900, the predictive CSI comprises a semi-persistent CSI that is sent on a PUSCH and that is activated by a DCI, and the method 900 further includes receiving, from the network, an RRC message comprising one of: a CSI-ReportConfig 1E comprising a value for the duration d; and CSI-SemiPersistentOnPUSCH-TriggerState IE comprising the value for the duration d.

In some embodiments of the method 900, the predictive CSI comprises a semi-persistent CSI that is sent on a PUSCH and that is activated by a DCI, and the method 900 further includes receiving, from the network, a MAC-CE comprising a value for the duration d.

In some embodiments of the method 900, the predictive CSI comprises a semi-persistent CSI that is sent on a PUSCH and that is activated by a DCI, and wherein the DCI comprises one of: an absolute value of the duration d in terms of a number of symbols; and an index corresponding to a table for values for the duration d that is configured at the UE. In some such embodiments, the one of the absolute value and the index are provided by the DCI in a TDRA field.

In some embodiments of the method 900, the predictive CSI comprises an aperiodic CSI that is sent on a PUSCH and that is triggered by a DCI, and the method 900 further includes receiving, from the network, an RRC message comprising one of: a CSI-ReportConfig 1E comprising a value for the duration d; a CSI-AperiodicTriggerState IE comprising the value for the duration d; and a CSI-AssociatedReportConfigInfo IE comprising the value for the duration d.

In some embodiments of the method 900, the predictive CSI comprises an aperiodic CSI that is sent on a PUSCH and that is triggered by a DCI, and the method 900 further includes receiving, from the network, a medium access control control element (MAC-CE) comprising the value for the duration d.

In some embodiments of the method 900, the predictive CSI comprises an aperiodic CSI that is sent on a PUSCH and that is triggered by a DCI, and wherein the DCI comprises one of: an absolute value of the duration d in terms of a number of symbols; and an index corresponding to a table for values for the duration d that is configured at the UE. In some such embodiments the one of the absolute value and the index are provided by the DCI in a CSI request field.

FIG. 10 illustrates a method 1000 of a RAN, according to embodiments herein. The method 1000 includes transmitting 1002, to a UE, configuration information for generating predictive CSI corresponding to a T_{CSI} occurring after a T_{RS} for an RS sent to the UE for generating the predictive CSI; wherein the T_{CSI} occurs after a duration d following T_{ref,CSI}.

The method 1000 further includes sending 1004, to the UE, the RS.

The method 1000 further includes receiving 1006, from the UE, the predictive CSI.

In some embodiments of the method 1000, the configuration information indicates that the T_{ref,CSI} is equal to a Tᵣₑₚₒᵣₜ.

In some embodiments of the method 1000, the configuration information indicates that the T_{ref,CSI} is equal to a T_{ref,RS}.

In some embodiments of the method 1000, the configuration information indicates that the T_{ref,CSI} is equal to the T_{RS} for the RS.

In some embodiments of the method 1000, the configuration information indicates that the T_{ref,CSI} ais equal to a T_{ref,DCI}.

In some embodiments of the method 1000, the configuration information comprises a value of the T_{ref,CSI}.

In some embodiments of the method 1000, the predictive CSI comprises a periodic CSI that is sent on a PUCCH, and the method 1000 further includes one of: sending, to the UE, a radio resource control (RRC) message comprising a CSI-ReportConfig IE comprising a value for the duration d; and sending, to the UE a MAC-CE comprising the value for the duration d.

In some embodiments of the method 1000, the predictive CSI comprises a semi-persistent CSI that is sent on a PUCCH and that is activated by a MAC-CE, and the method 1000 further includes sending, to the UE, an RRC message comprising a CSI-ReportConfig 1E comprising a value for the duration d.

In some embodiments of the method 1000, the predictive CSI comprises a semi-persistent CSI that is sent on a PUCCH and that is activated by a MAC-CE, and wherein the MAC-CE comprises a value for the duration d.

In some embodiments of the method 1000, the predictive CSI comprises a semi-persistent CSI that is sent on a PUSCH and that is activated by a DCI, and the method 1000 further includes sending, to the UE, an RRC message comprising one of: a CSI-ReportConfig information element (IE) comprising a value for the duration d; and CSI-SemiPersistentOnPUSCH-TriggerState IE comprising the value for the duration d.

In some embodiments of the method 1000, the predictive CSI comprises a semi-persistent CSI that is sent on a PUSCH and that is activated by a DCI, and the method 1000 further includes sending, to the UE, a MAC-CE comprising a value for the duration d.

In some embodiments of the method 1000, the predictive CSI comprises a semi-persistent CSI that is sent on a PUSCH and that is activated by a DCI, and wherein the DCI comprises one of: an absolute value of the duration d in terms of a number of symbols; and an index corresponding to a table for values for the duration d that is configured at the UE. In some such embodiments, the one of the absolute value and the index are provided by the DCI in a TDRA field.

In some embodiments of the method 1000, the predictive CSI comprises an aperiodic CSI that is sent on a PUSCH and that is triggered by a DCI, and the method 1000 further includes sending, to the UE, an RRC message comprising one of: a CSI-ReportConfig 1E comprising a value for the duration d; a CSI-AperiodicTriggerState IE comprising the value for the duration d; and a CSI-AssociatedReportConfigInfo IE comprising the value for the duration d.

In some embodiments of the method 1000, the predictive CSI comprises an aperiodic CSI that is sent on a PUSCH and that is triggered by a DCI, and the method 1000 further includes sending, to the UE, a MAC-CE comprising the value for the duration d.

In some embodiments of the method 1000, the predictive CSI comprises an aperiodic CSI that is sent on a PUSCH and that is triggered by a DCI, and wherein the DCI comprises one of: an absolute value of the duration d in terms of a number of symbols; and an index corresponding to a table for values for the duration d that is configured at the UE. In some such embodiments, the one of the absolute value and the index are provided by the DCI in a CSI request field.

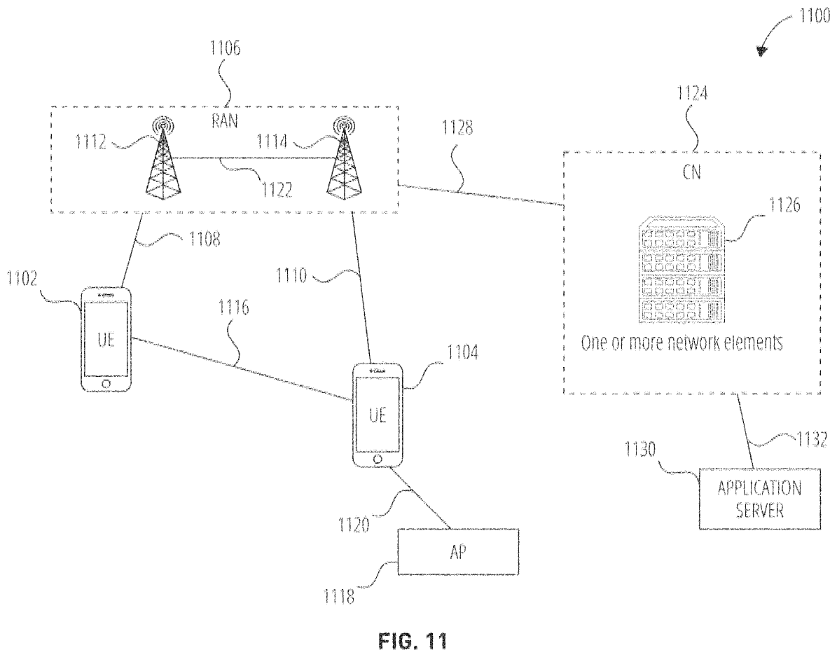

FIG. 11 illustrates an example architecture of a wireless communication system 1100, according to embodiments disclosed herein. The following description is provided for an example wireless communication system 1100 that operates in conjunction with the LTE system standards and/or 5G or NR system standards as provided by 3GPP technical specifications.

As shown by FIG. 11, the wireless communication system 1100 includes UE 1102 and UE 1104 (although any number of UEs may be used). In this example, the UE 1102 and the UE 1104 are illustrated as smartphones (e.g., handheld touchscreen mobile computing devices connectable to one or more cellular networks), but may also comprise any mobile or non-mobile computing device configured for wireless communication.

The UE 1102 and UE 1104 may be configured to communicatively couple with a RAN 1106. In embodiments, the RAN 1106 may be NG-RAN, E-UTRAN, etc. The UE 1102 and UE 1104 utilize connections (or channels) (shown as connection 1108 and connection 1110, respectively) with the RAN 1106, each of which comprises a physical communications interface. The RAN 1106 can include one or more base stations (such as base station 1112 and base station 1114) that enable the connection 1108 and connection 1110.

In this example, the connection 1108 and connection 1110 are air interfaces to enable such communicative coupling, and may be consistent with RAT(s) used by the RAN 1106, such as, for example, an LTE and/or NR.

In some embodiments, the UE 1102 and UE 1104 may also directly exchange communication data via a sidelink interface 1116. The UE 1104 is shown to be configured to access an access point (shown as AP 1118) via connection 1120. By way of example, the connection 1120 can comprise a local wireless connection, such as a connection consistent with any IEEE 802.11 protocol, wherein the AP 1118 may comprise a Wi-Fi® router. In this example, the AP 1118 may be connected to another network (for example, the Internet) without going through a CN 1124.

In embodiments, the UE 1102 and UE 1104 can be configured to communicate using orthogonal frequency division multiplexing (OFDM) communication signals with each other or with the base station 1112 and/or the base station 1114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1112 or base station 1114 may be implemented as one or more software entities running on server computers as part of a virtual network. In addition, or in other embodiments, the base station 1112 or base station 1114 may be configured to communicate with one another via interface 1122. In embodiments where the wireless communication system 1100 is an LTE system (e.g., when the CN 1124 is an EPC), the interface 1122 may be an X2 interface. The X2 interface may be defined between two or more base stations (e.g., two or more eNBs and the like) that connect to an EPC, and/or between two eNBs connecting to the EPC. In embodiments where the wireless communication system 1100 is an NR system (e.g., when CN 1124 is a 5GC), the interface 1122 may be an Xn interface. The Xn interface is defined between two or more base stations (e.g., two or more gNBs and the like) that connect to 5GC, between a base station 1112 (e.g., a gNB) connecting to 5GC and an eNB, and/or between two eNBs connecting to 5GC (e.g., CN 1124).

The RAN 1106 is shown to be communicatively coupled to the CN 1124. The CN 1124 may comprise one or more network elements 1126, which are configured to offer various data and telecommunications services to customers/subscribers (e.g., users of UE 1102 and UE 1104) who are connected to the CN 1124 via the RAN 1106. The components of the CN 1124 may be implemented in one physical device or separate physical devices including components to read and execute instructions from a machine-readable or computer-readable medium (e.g., a non-transitory machine-readable storage medium).

In embodiments, the CN 1124 may be an EPC, and the RAN 1106 may be connected with the CN 1124 via an S1 interface 1128. In embodiments, the S1 interface 1128 may be split into two parts, an S1 user plane (S1-U) interface, which carries traffic data between the base station 1112 or base station 1114 and a serving gateway (S-GW), and the S1-MME interface, which is a signaling interface between the base station 1112 or base station 1114 and mobility management entities (MMEs).

In embodiments, the CN 1124 may be a 5GC, and the RAN 1106 may be connected with the CN 1124 via an NG interface 1128. In embodiments, the NG interface 1128 may be split into two parts, an NG user plane (NG-U) interface, which carries traffic data between the base station 1112 or base station 1114 and a user plane function (UPF), and the S1 control plane (NG-C) interface, which is a signaling interface between the base station 1112 or base station 1114 and access and mobility management functions (AMFs).

Generally, an application server 1130 may be an element offering applications that use internet protocol (IP) bearer resources with the CN 1124 (e.g., packet switched data services). The application server 1130 can also be configured to support one or more communication services (e.g., VOIP sessions, group communication sessions, etc.) for the UE 1102 and UE 1104 via the CN 1124. The application server 1130 may communicate with the CN 1124 through an IP communications interface 1132.

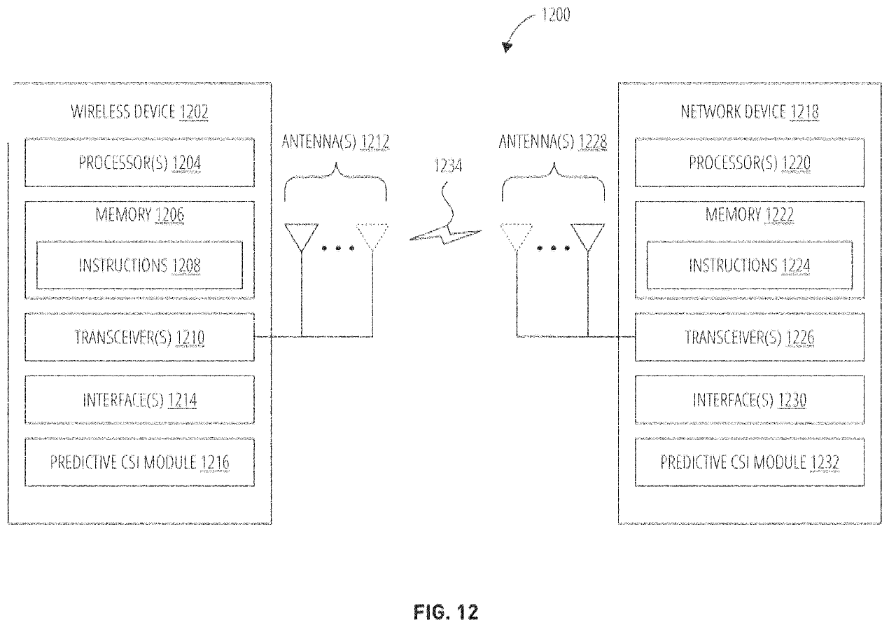

FIG. 12 illustrates a system 1200 for performing signaling 1234 between a wireless device 1202 and a network device 1218, according to embodiments disclosed herein. The system 1200 may be a portion of a wireless communications system as herein described. The wireless device 1202 may be, for example, a UE of a wireless communication system. The network device 1218 may be, for example, a base station (e.g., an eNB or a gNB) of a wireless communication system.

The wireless device 1202 may include one or more processor(s) 1204. The processor(s) 1204 may execute instructions such that various operations of the wireless device 1202 are performed, as described herein. The processor(s) 1204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1202 may include a memory 1206. The memory 1206 may be a non-transitory computer-readable storage medium that stores instructions 1208 (which may include, for example, the instructions being executed by the processor(s) 1204). The instructions 1208 may also be referred to as program code or a computer program. The memory 1206 may also store data used by, and results computed by, the processor(s) 1204.

The wireless device 1202 may include one or more transceiver(s) 1210 that may include radio frequency (RF) transmitter and/or receiver circuitry that use the antenna(s) 1212 of the wireless device 1202 to facilitate signaling (e.g., the signaling 1234) to and/or from the wireless device 1202 with other devices (e.g., the network device 1218) according to corresponding RATs.

The wireless device 1202 may include one or more antenna(s) 1212 (e.g., one, two, four, or more). For embodiments with multiple antenna(s) 1212, the wireless device 1202 may leverage the spatial diversity of such multiple antenna(s) 1212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1202 may be accomplished according to precoding (or digital beamforming) that is applied at the wireless device 1202 that multiplexes the data streams across the antenna(s) 1212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1202 may implement analog beamforming techniques, whereby phases of the signals sent by the antenna(s) 1212 are relatively adjusted such that the (joint) transmission of the antenna(s) 1212 can be directed (this is sometimes referred to as beam steering).

The wireless device 1202 may include one or more interface(s) 1214. The interface(s) 1214 may be used to provide input to or output from the wireless device 1202. For example, a wireless device 1202 that is a UE may include interface(s) 1214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1210/antenna(s) 1212 already described) that allow for communication between the UE and other devices and may operate according to known protocols (e.g., Wi-Fi®, Bluetooth®, and the like).

The wireless device 1202 may include a predictive CSI module 1216. The predictive CSI module 1216 may be implemented via hardware, software, or combinations thereof. For example, the predictive CSI module 1216 may be implemented as a processor, circuit, and/or instructions 1208 stored in the memory 1206 and executed by the processor(s) 1204. In some examples, the predictive CSI module 1216 may be integrated within the processor(s) 1204 and/or the transceiver(s) 1210. For example, the predictive CSI module 1216 may be implemented by a combination of software components (e.g., executed by a DSP or a general processor) and hardware components (e.g., logic gates and circuitry) within the processor(s) 1204 or the transceiver(s) 1210.

The predictive CSI module 1216 may be used for various aspects of the present disclosure, for example, aspects of FIG. 1 through FIG. 10. For example, the predictive CSI module 1216 may be configured to cause the wireless device 1202 to receive configuration for predictive CSI from a network device 1218 and/or generate and send predictive CSI to the network device 1218, in the manner described herein.

The network device 1218 may include one or more processor(s) 1220. The processor(s) 1220 may execute instructions such that various operations of the network device 1218 are performed, as described herein. The processor(s) 1220 may include one or more baseband processors implemented using, for example, a CPU, a DSP, an ASIC, a controller, an FPGA device, another hardware device, a firmware device, or any combination thereof configured to perform the operations described herein.

The network device 1218 may include a memory 1222. The memory 1222 may be a non-transitory computer-readable storage medium that stores instructions 1224 (which may include, for example, the instructions being executed by the processor(s) 1220). The instructions 1224 may also be referred to as program code or a computer program. The memory 1222 may also store data used by, and results computed by, the processor(s) 1220.

The network device 1218 may include one or more transceiver(s) 1226 that may include RF transmitter and/or receiver circuitry that use the antenna(s) 1228 of the network device 1218 to facilitate signaling (e.g., the signaling 1234) to and/or from the network device 1218 with other devices (e.g., the wireless device 1202) according to corresponding RATs.

The network device 1218 may include one or more antenna(s) 1228 (e.g., one, two, four, or more). In embodiments having multiple antenna(s) 1228, the network device 1218 may perform MIMO, digital beamforming, analog beamforming, beam steering, etc., as has been described.

The network device 1218 may include one or more interface(s) 1230. The interface(s) 1230 may be used to provide input to or output from the network device 1218. For example, a network device 1218 that is a base station may include interface(s) 1230 made up of transmitters, receivers, and other circuitry (e.g., other than the transceiver(s) 1226/antenna(s) 1228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1218 may include a predictive CSI module 1232. The predictive CSI module 1232 may be implemented via hardware, software, or combinations thereof. For example, the predictive CSI module 1232 may be implemented as a processor, circuit, and/or instructions 1224 stored in the memory 1222 and executed by the processor(s) 1220. In some examples, the predictive CSI module 1232 may be integrated within the processor(s) 1220 and/or the transceiver(s) 1226. For example, the predictive CSI module 1232 may be implemented by a combination of software components (e.g., executed by a DSP or a general processor) and hardware components (e.g., logic gates and circuitry) within the processor(s) 1220 or the transceiver(s) 1226.

The predictive CSI module 1232 may be used for various aspects of the present disclosure, for example, aspects of FIG. 1 through FIG. 10. The predictive CSI module 1232 may be configured to cause the network device 1218 to generate and send configuration information for predictive CSI to a wireless device 1202 in the manner described herein.

Embodiments contemplated herein include an apparatus comprising means to perform one or more elements of the method 900. This apparatus may be, for example, an apparatus of a UE (such as a wireless device 1202 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1206 of a wireless device 1202 that is a UE, as described herein).

Embodiments contemplated herein include an apparatus comprising logic, modules, or circuitry to perform one or more elements of the method 900. This apparatus may be, for example, an apparatus of a UE (such as a wireless device 1202 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1202 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1204 of a wireless device 1202 that is a UE, as described herein). These instructions may be, for example, located in the processor and/or on a memory of the UE (such as a memory 1206 of a wireless device 1202 that is a UE, as described herein).

Embodiments contemplated herein include an apparatus comprising means to perform one or more elements of the method 1000. This apparatus may be, for example, an apparatus of a base station (such as a network device 1218 that is a base station, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of a base station (such as a memory 1222 of a network device 1218 that is a base station, as described herein).

Embodiments contemplated herein include an apparatus comprising logic, modules, or circuitry to perform one or more elements of the method 1000. This apparatus may be, for example, an apparatus of a base station (such as a network device 1218 that is a base station, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of a base station (such as a network device 1218 that is a base station, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of a base station (such as a processor(s) 1220 of a network device 1218 that is a base station, as described herein). These instructions may be, for example, located in the processor and/or on a memory of the base station (such as a memory 1222 of a network device 1218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, configuration information for generating predictive channel state information (CSI) corresponding to a CSI valid time (T_{CSI}) occurring after a CSI reference signal (RS) time (T_{RS}) for an RS received at the UE for generating the predictive CSI; wherein the T_{CSI} occurs after a duration d following a CSI prediction reference time (T_{ref,CSI});
generating, based on a measurement of the RS, the predictive CSI corresponding to the T_{CSI}; and
transmitting, to the network, the predictive CSI at a CSI report time (Tᵣₑₚₒᵣₜ).

2. The method of claim 1, wherein the configuration information indicates that the T_{ref,CSI} is equal to the Tᵣₑₚₒᵣₜ.

3. The method of claim 1, wherein the configuration information indicates that the T_{ref,CSI} is equal to a CSI reference resource for the RS (T_{ref,RS}).

4. The method of claim 1, wherein the configuration information indicates that the T_{ref,CSI} is equal to the T_{RS} for the RS.

5. The method of claim 1, wherein the configuration information indicates that the T_{ref,CSI} is equal to a CSI reference time defined based on a final time the UE can receive a downlink control information (DCI) that schedules the predictive CSI report (T_{ref,DCI}).

6. The method of claim 1, wherein the configuration information comprises a value of the T_{ref,CSI}.

7. The method of claim 1, wherein the predictive CSI comprises a periodic CSI that is sent on a physical uplink control channel (PUCCH), and further comprising one of:
receiving, from the network, a radio resource control (RRC) message comprising a CSI-ReportConfig information element (IE) comprising a value for the duration d; and
receiving, from the network, a medium access control control element (MAC-CE) comprising the value for the duration d.

8. The method of claim 1, wherein the predictive CSI comprises a semi-persistent CSI that is sent on a physical uplink control channel (PUCCH) and that is activated by a medium access control control element (MAC-CE), and further comprising receiving, from the network, a radio resource control (RRC) message comprising a CSI-ReportConfig information element (IE) comprising a value for the duration d.

9. The method of claim 1, wherein the predictive CSI comprises a semi-persistent CSI that is sent on a physical uplink control channel (PUCCH) and that is activated by a medium access control control element (MAC-CE), and wherein the MAC-CE comprises a value for the duration d.

10. The method of claim 1, wherein the predictive CSI comprises a semi-persistent CSI that is sent on a physical uplink shared channel (PUSCH) and that is activated by a downlink control information (DCI), and further comprising receiving, from the network, a radio resource control (RRC) message comprising one of:
a CSI-ReportConfig information element (IE) comprising a value for the duration d; and
CSI-SemiPersistentOnPUSCH-TriggerState IE comprising the value for the duration d.

11. The method of claim 1, wherein the predictive CSI comprises a semi-persistent CSI that is sent on a physical uplink shared channel (PUSCH) and that is activated by a downlink control information (DCI), and further comprising receiving, from the network, a medium access control control element (MAC-CE) comprising a value for the duration d.

12. The method of claim 1, wherein the predictive CSI comprises a semi-persistent CSI that is sent on a physical uplink shared channel (PUSCH) and that is activated by a downlink control information (DCI), and wherein the DCI comprises one of:
an absolute value of the duration d in terms of a number of symbols; and
an index corresponding to a table for values for the duration d that is configured at the UE.

13. The method of claim 12, wherein the one of the absolute value and the index are provided by the DCI in a time domain resource allocation (TDRA) field.

14. The method of claim 1, wherein the predictive CSI comprises an aperiodic CSI that is sent on a physical uplink shared channel (PUSCH) and that is triggered by a downlink control information (DCI), and further comprising receiving, from the network, a radio resource control (RRC) message comprising one of:
a CSI-ReportConfig information element (IE) comprising a value for the duration d;
a CSI-AperiodicTriggerState IE comprising the value for the duration d; and
a CSI-AssociatedReportConfigInfo IE comprising the value for the duration d.

15. The method of claim 1, wherein the predictive CSI comprises an aperiodic CSI that is sent on a physical uplink shared channel (PUSCH) and that is triggered by a downlink control information (DCI), and further comprising receiving, from the network, a medium access control control element (MAC-CE) comprising the value for the duration d.

16. The method of claim 1, wherein the predictive CSI comprises an aperiodic CSI that is sent on a physical uplink shared channel (PUSCH) and that is triggered by a downlink control information (DCI), and wherein the DCI comprises one of:
an absolute value of the duration d in terms of a number of symbols; and
an index corresponding to a table for values for the duration d that is configured at the UE.

17. The method of claim 16, wherein the one of the absolute value and the index are provided by the DCI in a CSI request field.

18. A method of a radio access network (RAN), comprising:
transmitting, to a user equipment (UE), configuration information for generating predictive channel state information (CSI) corresponding to a CSI valid time (T_{CSI}) occurring after a reference signal (RS) time (T_{RS}) for an RS sent to the UE for generating the predictive CSI; wherein the T_{CSI} occurs after a duration d following a CSI prediction reference time (T_{ref,CSI});
sending, to the UE, the RS; and
receiving, from the UE, the predictive CSI.

19. The method of claim 18, wherein the configuration information indicates that the T_{ref,CSI} is equal to a CSI report time (Tᵣₑₚₒᵣₜ).

20. The method of claim 18, wherein the configuration information indicates that the T_{ref,CSI} is equal to a CSI reference resource for the RS (T_{ref,RS}).

21-37. (canceled)
